(19) United States
(12) Patent Application Publication
(10) Pub. No.: US 2013/0190078 A1
(43) Pub. Date: Jul. 25, 2013

(54) RELAY DEVICE AND GAME SYSTEM

(71) Applicants: Nobuhiro Goto, Minato-ku (JP); Tetsuo Ishida, Minato-ku (JP); Jun Komatsu, Minato-ku (JP); Yuichi Nakahara, Minato-ku (JP); Teruhiko Kimura, Minato-ku (JP)

(72) Inventors: Nobuhiro Goto, Minato-ku (JP); Tetsuo Ishida, Minato-ku (JP); Jun Komatsu, Minato-ku (JP); Yuichi Nakahara, Minato-ku (JP); Teruhiko Kimura, Minato-ku (JP)

(73) Assignee: KONAMI DIGITAL ENTERTAINMENT CO., LTD., Minato-ku, Tokyo (JP)

(21) Appl. No.: 13/876,647

(22) PCT Filed: Dec. 20, 2011
(86) PCT No.: PCT/JP2011/079502

§ 371 Date: Mar. 28, 2013

(30) Foreign Application Priority Data
Jan. 19, 2011 (JP) 2011-009254

(51) Int. Cl. G07F 17/32

(52) U.S. Cl. CPC G07F 17/3248
USPC 463/25

(57) ABSTRACT

A relay device connected to a game device receives an increase instruction for increasing a credit number via a communication unit that communicates with an outside, and stores the credit number to be increased. The relay device generates pseudo medal detection pulses, and supplies medal detection pulses obtained by a logical sum between normal medal detection pulses that are generated in the game device and the pseudo medal detection pulses to a game device. When receiving the increase instruction, the relay device generates a pseudo discharge signal that gives an instruction to discharge medals inserted in the game device out of the device, and supplies a discharge signal obtained by a logical sum between a normal discharge signal that is generated in the game device and the pseudo discharge signal to the game device. After the pseudo discharge signal is generated, the relay device generates the pseudo medal detection pulses, whose number corresponds to the credit number stored in a storage unit.

### TECHNICAL FIELD

The present invention relates to technology for managing credits used in game devices.

### BACKGROUND ART

Generally, according to game devices that use medals and that are set up in game arcades and the like, game progress is controlled on condition that players bet the medals, and the medals whose number corresponds to the result of the game are given to the players. In this specification, the medal is a disc-shaped object that may be referred to as a token coin or simply a coin. A system that has a number of such game devices connected via a communication network and that executes a jackpot lottery is known (Patent Document 1, for example). In such a system, a number corresponding to a part of the number of the medals bet by the player is added cumulatively in a management device, and the jackpot lottery is executed targeting the game devices whose players are participating in the game. Then, a large amount of medals whose number corresponding to the accumulated number are given to a winning game device.

Further, technology to use a medal storage device that associates and stores a total credit number owned by the player (owned credit number) and identification information of the player, in the game device in the game arcade or the like has been proposed conventionally. In Patent Document 2, for example, such technology is disclosed that the identification information recorded in an IC card of the player is transferred from the game device to the medal storage device, and an owned credit that is stored in association with the identification information is used in the game device, according to an instruction from the player.

### PRIOR ART DOCUMENTS

### Patent Documents

Patent Document 1: JP-A-2010-179059

Patent Document 2: JP-A-2008-29513

### SUMMARY OF INVENTION

According to the system described in Patent Document 1, however, the game device needs to have an interface for connection with the management device in advance, because the game device that can be subjected to the jackpot lottery has to be connected to the management device. Also, according to the system described in Patent Document 2, the game device needs to have the interface for connection with the medal storage device in advance, because the game device has to be connected to the medal storage device in order to use the medal storage device in the game device. For this reason, there is a problem in that the game device not having the interface for connection with the management device and the medal storage device cannot use the function provided between itself, the management device and the medal storage device.

The present invention is made in view of the above-described circumstances, and the problem to be solved by the present invention is to allow a game device, not having a dedicated interface for connection with external devices such as a management device and a medal storage device, to be connected to the external devices.

Means to be adopted by the present invention to solve the above-described problem will be explained.

According to the first aspect of the present invention, a relay device connected to a game device. The game device includes a first output unit adapted to detect medals inserted from a medal insertion port by a medal insertion sensor, and adapted to output normal medal detection pulses; a first input unit supplied with medal detection pulses; a credit management unit adapted to count up and manage a credit number corresponding to the medal detection pulses supplied to the first input unit; a second output unit adapted to output a normal discharge signal that causes the inserted medals to be discharged out of the device; a second input unit supplied with a discharge signal; and a discharge unit adapted to discharge the inserted medals out of the device, without causing the medal insertion sensor to detect the inserted medals, according to the discharge signal supplied to the second input unit. The relay device includes: a communication unit adapted to communicate with an outside device; an instruction reception unit adapted to receive an increase instruction that increases the credit number via the communication unit; a storage unit adapted to store a first increase credit number as the credit number to be increased, shown by the increase instruction; a pseudo medal detection pulse generation unit adapted to generate pseudo medal detection pulses; a first relay output unit adapted to output the medal detection pulses obtained by a logical sum between the normal medal detection pulses and the pseudo medal detection pulses to the first input unit; a pseudo discharge signal generation unit adapted to generate a pseudo discharge signal that gives an instruction to discharge the inserted medals out of the device in case in which the instruction reception unit has received the increase instruction; a second relay output unit adapted to output the discharge signal obtained by a logical sum between the normal discharge signal and the pseudo discharge signal to the second input unit; and a control unit adapted to cause the pseudo medal detection pulse generation unit to generate the pseudo medal detection pulses, whose number corresponds to the first increase credit number stored in the storage unit, after the pseudo discharge signal is generated.

In this specification, the signal or pulses added with the word “normal” are generated in the game device that does not have a dedicated interface for connection with external devices, and have original purposes in the game device. More specifically, when the game device is not connected to the relay device according to the present invention, the signal or pulses added with “normal” are used herein for the purpose similar to the signal or pulses without “normal” or “pseudo” added thereto. For example, the “normal medal detection pulses” are generated in the game device and, when the game device is not connected to the relay device according to the present invention, are equal to the “medal detection pulses” and used to increase the credit number in the game device.

In this specification, the signal or pulses added with the word “pseudo” are generated in the relay device according to the present invention, and used to cause the game device, being connected to the relay device according to the present invention and not having a dedicated interface for connection with external devices, to recognize as if the signal or pulses without the addition of the word “normal” or “pseudo” are generated in the game device. For example, the “pseudo discharge signal” is generated in the relay device, and the “discharge signal” is supplied from the relay device to the game device as the “pseudo discharge signal” is generated.

According to this aspect of the present invention, it is possible for the game device unable to communicate with the outside to receive the increase instruction from the outside. When the increase instruction specifies that the credit is increased by the first increase credit number, it is possible to increase the credit number held in the game device by generating the pseudo medal detection pulses and supplying these to the game device. Further, the relay device generates the pseudo medal detection pulses after supplying the pseudo discharge signal to the game device, which makes it possible to prevent a conflict between the pseudo medal detection pulses and the normal medal detection pulses.

The first relay output unit outputs the medal detection pulses obtained by the logical sum between the normal medal detection pulses and the pseudo medal detection pulses, and the second relay output unit outputs the signal obtained by the logical sum between the discharge signal and the pseudo discharge signal. The “logical sum” includes both of the logical sum in positive logic and the logical sum in negative logic.

According to a second aspect of the present invention, a relay device is connected to a game device. The game device includes: a first output unit adapted to detect medals inserted from a medal insertion port by a medal insertion sensor, and adapted to output normal medal detection pulses; a first input unit supplied with medal detection pulses; a credit management unit adapted to count up and manage a credit number corresponding to the medal detection pulses supplied to the first input unit; a second output unit adapted to output a normal discharge signal that causes the inserted medals to be discharged out of the device; a second input unit supplied with a discharge signal; and a discharge unit adapted to discharge the inserted medals out of the device, without causing the medal insertion sensor to detect the inserted medals, according to the discharge signal supplied to the second input unit. The relay device includes: a communication unit adapted to communicate with an outside device; an instruction reception unit adapted to receive an increase instruction that increases the credit number via the communication unit; a normal medal detection pulse input unit supplied with the normal medal detection pulses outputted from the first output unit; a pseudo medal detection pulse generation unit adapted to generate pseudo medal detection pulses; a storage unit adapted to store a first increase credit number as the credit number to be increased shown by the increase instruction, and a second increase credit number obtained by counting the normal medal detection pulses supplied to the normal medal detection pulse input unit; a pseudo discharge signal generation unit adapted to generate a pseudo discharge signal that gives an instruction to discharge the inserted medals out of the device; a second relay output unit adapted to output the discharge signal obtained by a logical sum between the normal discharge signal and the pseudo discharge signal to the second input unit; and a control unit adapted to cause the pseudo medal detection pulse generation unit to generate the pseudo medal detection pulses, whose number corresponds to the first increase credit number and the second increase credit number stored in the storage unit, after the pseudo discharge signal is generated.

According to this aspect of the present invention, it is possible for the game device incapable of communicating with the outside to receive the increase instruction from the outside. When the increase instruction specifies that the credit is increased by the first increase credit number, it is possible to increase the credit number held in the game device by generating the pseudo medal detection pulses and supplying these to the game device. Further, the relay device generates the pseudo medal detection pulses after supplying the pseudo discharge signal to the game device, which makes it possible to prevent the conflict between the pseudo medal detection pulses and the normal medal detection pulses. Furthermore, when the player inserts the medals into the medal insertion port, the normal medal detection pulses whose number corresponds to the number of the medals are generated. The relay device counts the number of the normal medal detection pulses, and stores the number as the second increase credit number. Then, the pseudo medal detection pulses whose number corresponds to the second credit number are generated. Thus, it is possible to deal with the second increase credit number that is generated in the game device and the first increase credit number that is generated outside the game device in a similar manner.

The second relay output unit outputs the signal obtained by the logical sum between the discharge signal and the pseudo discharge signal. The “logical sum” includes both of the logical sum in positive logic and the logical sum in negative logic.

With the relay device according to the above-described first aspect, it is preferable that the relay device further includes an acquisition credit number input unit adapted to allow a player to input an acquisition credit number as the credit number to be acquired in the game device, out of the first increase credit number stored in the storage unit; and an acquisition instruction unit adapted to allow the player to input an acquisition instruction to acquire the acquisition credit number to the game device. It is preferable that the control unit update contents stored in the storage unit by a new first increase credit number obtained by subtracting the acquisition credit number from the first increase credit number after the acquisition instruction is inputted, and cause the pseudo medal detection pulse generation unit to generate the pseudo medal detection pulses, whose number corresponds to the acquisition credit number, after the pseudo discharge signal is generated.

According to this structure, it is possible to transfer a part of the first increase credit number regarding the increase instruction to the game device. Thus, the player can freely decide the amount to be transferred. Supposing that, for example, the player wins the jackpot lottery and the first increase credit number of 5,000 is given to the player. Acquisition of the entirety in the game device is time-consuming because it is necessary to generate the 5,000 pseudo medal detection pulses. Some players may wish to increase the credit number by an appropriate number and start the next game as quickly as possible. According to this structure, it is possible for the player to set the acquisition credit number, so that the player's wish with regard to the game progress can be fulfilled.

With the relay device according to the above-described second aspect, it is preferable that the relay device further includes an acquisition credit number input unit adapted to allow a player to input an acquisition credit number as the credit number to be acquired in the game device, out of the increase credit number stored in the storage unit; and an acquisition instruction unit adapted to allow the player to input an acquisition instruction to acquire the acquisition credit number to the game device. It is preferable that the control unit cause the storage unit to store an increase credit number obtained by making an operation to obtain a sum of the first increase credit number and the second increase credit number, instead of causing the storage unit to store the first increase credit number and the second increase credit number, and the control unit update contents stored in the storage unit by a new increase credit number obtained by subtracting the acquisition credit number from the increase credit number after the acquisition instruction is inputted, and cause the pseudo medal detection pulse generation unit to generate the pseudo medal detection pulses, whose number corresponds to the acquisition credit number, after the pseudo discharge signal is generated.

According to this structure, the control unit manages the increase credit number obtained by adding the first increase credit number and the second increase credit number. In other words, it is not necessary to manage the first increase credit number and the second increase credit number separately, which makes it possible to simplify the process. Further, it is possible for the player to set the acquisition credit number, so that the player's wish with regard to the game progress can be fulfilled.

With the above-described relay device, it is preferable that the relay device further include display unit adapted to display information; and an inserting pulse interval detection unit adapted to cause the display unit to display an image encouraging the player to insert the medals consecutively, and to measure a pulse interval of the normal medal detection pulses. It is preferable that the pseudo medal detection pulse generation unit control the pulse interval of the pseudo medal detection pulses so that the pulse interval of the pseudo medal detection pulses is greater than a minimum pulse interval among a plurality of pulse intervals measured by the inserting pulse interval detection unit.

According to this structure, it is possible to cause the pulse interval of the pseudo medal detection pulses to correspond to the pulse interval of the medals actually inserted. Thus, it is possible to prevent the game device from malfunctioning or performing an error process by judging the condition of the game device to be abnormal. The inserting pulse interval detection unit detects a time from a falling edge of one normal medal detection pulse to a rising edge of the next normal medal detection pulse, a time from a rising edge of one normal medal detection pulse to a falling edge of the next normal medal detection pulse, a time from the falling edge of one normal medal detection pulse to a falling edge of the next normal medal detection pulse, or a time from a rising edge of one normal medal detection pulse to a rising edge of the next normal medal detection pulse, as the pulse interval of the normal medal detection pulses. “Control the pulse interval of the pseudo medal detection pulses . . . greater than a minimum pulse interval” includes the case where, for example, an average value of a plurality of pulse intervals is set as the pulse interval of the pseudo medal detection pulses.

With the above-described relay device, it is preferable that the game device include a hopper to store the medals, a motor provided to the hopper to operate for paying out the medals, a main body board adapted to output a normal drive signal for operating the motor, a medal paying-out sensor to detect the medals paid out from the hopper and to output normal medal paying-out pulses, a medal paying-out pulse input unit supplied with the medal paying-out pulses, and a management unit adapted to count the medal paying-out pulses supplied to the medal paying-out pulse input unit and to subtract a result of the count from the credit number. It is preferable that the communication unit communicate with a credit storage device. Further, it is preferable that the relay device includes a transfer input unit adapted to allow the player to input an output instruction that gives an instruction to output the credit number held in the game device, a motor control unit adapted to supply to the motor a pseudo drive signal that stops operation of the motor when the output instruction is inputted to the transfer input unit, a pseudo medal paying-out pulse generation unit adapted to output pseudo medal paying-out pulses during a period when sensing the normal drive signal that is outputted from the main body board and that operates the motor, after stopping the operation of the motor, a medal paying-out pulse output unit adapted to output to the medal paying-out pulse input unit the medal paying-out pulses obtained by a logical sum between the normal medal paying-out pulses and the pseudo medal paying-out pulses, and a credit number transfer unit adapted to generate a credit number to be transferred from the game device to the credit storage device according to a number of the pseudo medal paying-out pulses outputted from the pseudo medal paying-out pulse generation unit, and to transfer the generated credit number to the credit storage device via the communication unit.

According to this structure, the credit number held in the game device can be transferred to the outside and stored in the external credit storage device. As the credit number transfer unit outputs the pseudo medal paying-out pulses to the game device after stopping the operation of the motor, it is possible to reduce the credit number held in the game device and to transfer the credit number corresponding to the number of the pseudo medal paying-out pulses.

Here, “to count the medal paying-out pulses . . . and to subtract a result of the count from the credit number” includes the case where one credit is subtracted for one pulse. A plurality of counts may be subtracted collectively.

With the above-described relay device, it is preferable that the relay device further include a monitor unit adapted to monitor a control signal of an element of the game device; and a pseudo game participation information transmission unit adapted to generate pseudo bet information corresponding to bet information or pseudo win information corresponding to win information that show an extent of participation in the game by the player, based on at least the control signal monitored by the monitor unit, and to transmit the information to a management device via the communication unit. According to this structure, the pseudo bet information or the pseudo win information may be used as an index showing the extent of the participation in the game by the player.

The bet information is the information showing the extent that the player participates in the game of the game device, and specifically, the number of bets made by the player to the game device. The win information is the information showing the extent that the player participates in the game of the game device, and specifically, the number of wins made by the player in the game device. When the relay device can acquire the bet information and the win information from the game device, the relay device may generate the pseudo bet information or the pseudo win information based on the bet information or the win information as control information. When the relay device cannot acquire the bet information and the win information themselves from the game device, the control signal other than the bet information or the win information may be used to generate the pseudo bet information showing the number of the assumed bets made by the player to the game device, or the pseudo win information showing the number of the assumed wins made by the player in the game device, and to transmit the information to the management device. The management device may execute the jackpot lottery according to the received bet number information or the win information, irrespective of whether the received information is the normal bet information, the normal win information, the pseudo bet information or the pseudo win information.

With the above-described relay device, it is preferable that the relay device further include a reading unit (240) adapted to read identification information from a recording medium recording the identification information for identifying the player, and to output a read out signal. It is preferable that the pseudo game participation information transmission unit generates the pseudo bet information corresponding to the bet information or the pseudo win information corresponding to the win information that show the extent of participation in the game by the player, based on at least the read out signal and the control signal monitored by the monitor unit, and to transmit the information to the management device via the communication unit. According to this structure, the pseudo bet information or the pseudo win information is generated by using the identification information, so that the probability of the participation in the game can be determined more precisely.

According to an aspect of the present invention, a game system includes a management device; a plurality of first game devices adapted not to communicate with the management device; a plurality of second game devices adapted to communicate with the management device; and a plurality of relay devices provided correspondingly to the plurality of first game devices. Each of the plurality of first game devices includes a first output unit adapted to detect medals inserted from a medal insertion port by a medal insertion sensor, and to output normal medal detection pulses, a first input unit supplied with medal detection pulses, a credit management unit adapted to count up and manage a credit number corresponding to the medal detection pulses supplied to the first input unit, a second output unit adapted to output a normal discharge signal that causes the inserted medals to be discharged out of the device, a second input unit supplied with a discharge signal, and a discharge unit adapted to discharge the inserted medals out of the device, without causing the medal insertion sensor to detect the inserted medals, according to the discharge signal supplied to the second input unit. Each of the plurality of relay devices includes a communication unit adapted to communicate with the management device, an instruction reception unit adapted to receive an increase instruction that increases the credit number via the communication unit, a storage unit adapted to store a first increase credit number as the credit number to be increased shown by the increase instruction, a pseudo medal detection pulse generation unit adapted to generate pseudo medal detection pulses, a first relay output unit adapted to output the medal detection pulses obtained by a logical sum between the normal medal detection pulses and the pseudo medal detection pulses to the first input unit, a pseudo discharge signal generation unit adapted to generate a pseudo discharge signal that gives an instruction to discharge the inserted medals out of the device when the instruction reception unit receives the increase instruction, a second relay output unit adapted to output the discharge signal obtained by a logical sum between the normal discharge signal and the pseudo discharge signal to the second input unit, and a control unit adapted to cause the pseudo medal detection pulse generation unit to generate the pseudo medal detection pulses, whose number corresponds to the first increase credit number stored in the storage unit, after the pseudo discharge signal is generated.

According to another aspect of the present invention, a game system includes a management device; a plurality of first game devices adapted not to communicate with the management device; a plurality of second game devices adapted to communicate with the management device; and a plurality of relay devices provided correspondingly to the plurality of first game devices. Each of the plurality of first game devices includes a first output unit adapted to detect medals inserted from a medal insertion port by a medal insertion sensor, and to output normal medal detection pulses, a first input unit supplied with medal detection pulses, a credit management unit adapted to count up and manage a credit number corresponding to the medal detection pulses supplied to the first input unit, a second output unit adapted to output a normal discharge signal that causes the inserted medals to be discharged out of the device, a second input unit supplied with a discharge signal, and a discharge unit adapted to discharge the inserted medals out of the device, without causing the medal insertion sensor to detect the inserted medals, according to the discharge signal supplied to the second input unit. Each of the plurality of relay devices includes a communication unit adapted to communicate with the management device, an instruction reception unit adapted to receive an increase instruction that increases the credit number via the communication unit, a normal medal detection pulse input unit supplied with the normal medal detection pulses outputted from the first output unit, a pseudo medal detection pulse generation unit adapted to generate pseudo medal detection pulses, a storage unit adapted to store a first increase credit number as the credit number to be increased shown by the increase instruction, and a second increase credit number obtained by counting the normal medal detection pulses supplied to the normal medal detection pulse input unit, a pseudo discharge signal generation unit adapted to generate a pseudo discharge signal that gives an instruction to discharge the inserted medals out of the device, a second relay output unit adapted to output the discharge signal obtained by a logical sum between the normal discharge signal and the pseudo discharge signal to the second input unit, and a control unit adapted to cause the pseudo medal detection pulse generation unit to generate the pseudo medal detection pulses, whose number corresponds to the first increase credit number and the second increase credit number stored in the storage unit, after the pseudo discharge signal is generated.

The “credit” means an amount of game values used in the game (consumed by bets and given by wins) that typically corresponds to a virtual amount that corresponds to an amount of physical game media, such as medals (token coins), tokens not having a disc shape, coins as money circulating in the society or the like. For example, the credit increases when the game media are inserted in the game device and the game media are acquired according to the result of the game, and the credit decreases when bets are placed on the game and the like.

### BRIEF DESCRIPTION OF DRAWINGS

FIG. 1 is a block diagram of a game system according to an embodiment of the present invention;

FIG. 2A is a perspective view showing a game device in the game system;

FIG. 2B is a block diagram showing the structure of the game device of FIG. 2A;

FIG. 3 is a block diagram showing the structure of a relay device in the game system;

FIG. 4 is a flowchart showing details of a credit increase process executed in the relay device;

FIG. 5A is an explanatory view showing a logical sum circuit provided in the relay device;

FIG. 5B is an explanatory view showing an OR circuit that can be used as the logical sum circuit of FIG. 5A;

FIG. 5C is an explanatory view showing a wired-OR circuit that can be used as the logical sum circuit of FIG. 5A;

FIG. 5D is an explanatory view showing an AND circuit that can be used instead of the logical sum circuit of FIG. 5A;

FIG. 5E is an explanatory view showing another representation of the AND circuit in FIG. 5D;

FIG. 5F is an explanatory view showing another logical sum circuit provided in the relay device;

FIG. 5G is an explanatory view showing an OR circuit that can be used as the logical sum circuit of FIG. 5F;

FIG. 5H is an explanatory view showing a wired-OR circuit that can be used as the logical sum circuit of FIG. 5F;

FIG. 5I is an explanatory view showing an AND circuit that can be used instead of the logical sum circuit of FIG. 5F;

FIG. 5J is an explanatory view showing another representation of the AND circuit in FIG. 5I;

FIG. 6 is a timing chart of a pseudo discharge signal and pseudo medal detection pulses generated in the relay device;

FIG. 7 is a flowchart showing a pulse interval adjustment process executed in the relay device;

FIG. 8 is a flowchart showing a credit deposit process executed in the relay device; and

FIG. 9 is a block diagram showing a game device according to a modification example.

### DESCRIPTION OF EMBODIMENTS

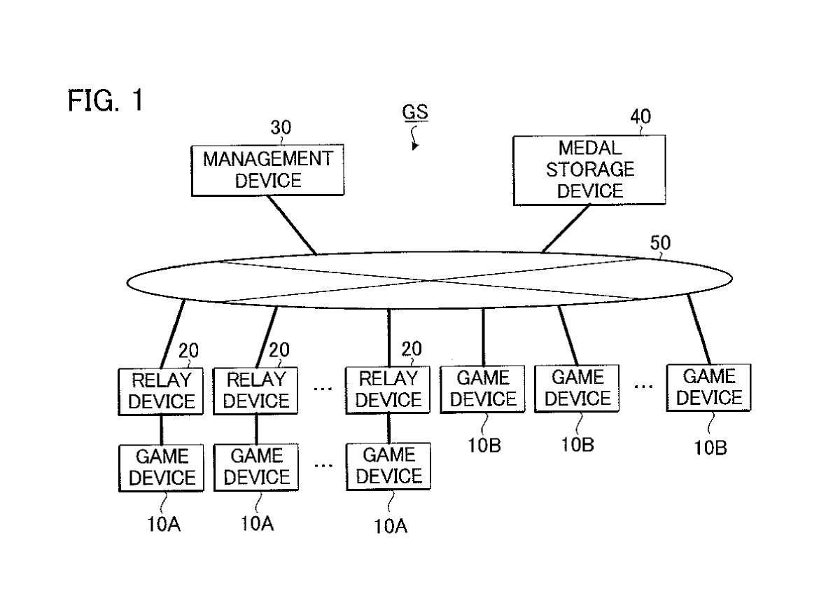

FIG. 1 is a block diagram of a game system GS according to an embodiment of the present invention. The game system GS is a computer network system set up in an amusement facility such as a game arcade, for example. As shown in FIG. 1, the game system GS includes a plurality of game devices 10A and relay devices 20, a plurality of game devices 10B, a management device 30, a medal storage device 40, and a communication network 50.

The management device 30 recognizes the number of medals that are bet to each of the game devices 10A and 10B and the number of medals that are won (given) in each of the game devices 10A and 10B, respectively, and executes a jackpot lottery. The jackpot lottery is executed targeting only the game device whose player is participating in the game, that is, the game device placing bets or the game device gaining wins, out of the respective game devices 10A and 10B.

The medal storage device (credit storage device) 40 is used to transfer a credit to be used in the game (deposit of the credit from the game device to the medal storage device 40 and paying-out of the credit from the medal storage device 40 to the game device).

Each of the game devices 10B includes an interface for connection with the management device 30 and the medal storage device 40. On the other hand, each of the game devices 10A does not include the interface for connection with the management device 30 and the medal storage device 40. Each of the relay devices 20 is used in conjunction with the game device 10A and functions as the interface for connection with the management device 30 and the medal storage device 40. When the system is structured like this, it is possible to deal with the game devices 10A, not having the interface for connection with the management device 30 and the medal storage device 40, collectively with the game devices 10B, to manage the number of inserted medals and the number of paid-out medals, or the number of bets and the number of wins of the respective game devices in the amusement facility (manage an operating ratio of the respective game devices and the like), to increase the targets for the jackpot lottery by recognizing the bets to the respective devices and the wins in the respective game devices, and further to enable the transfer of the medals between the respective game devices and the medal storage device 40.

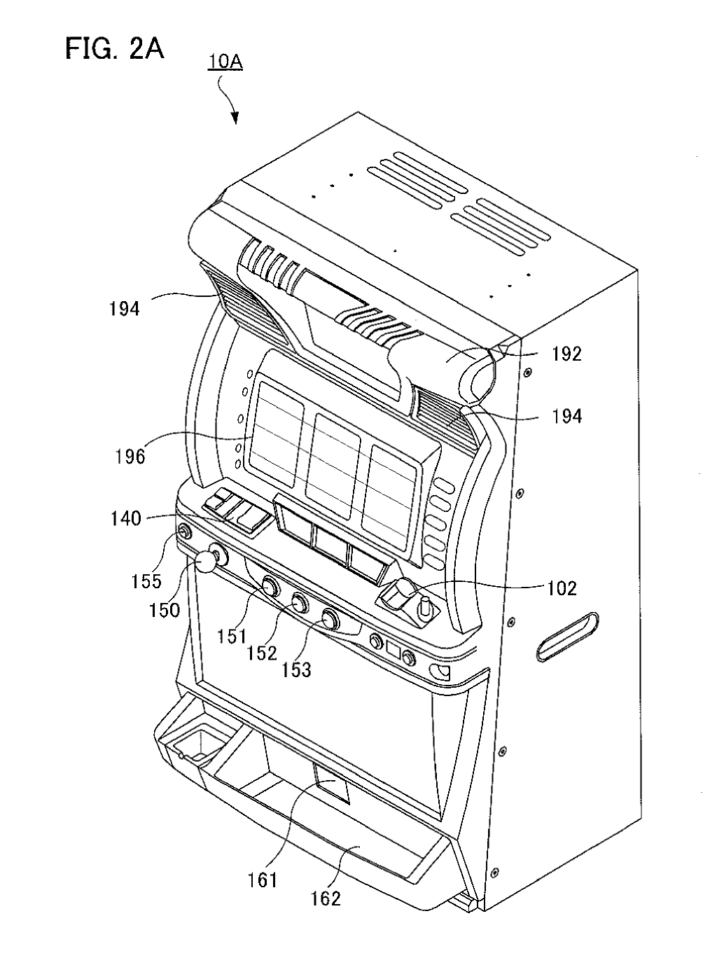

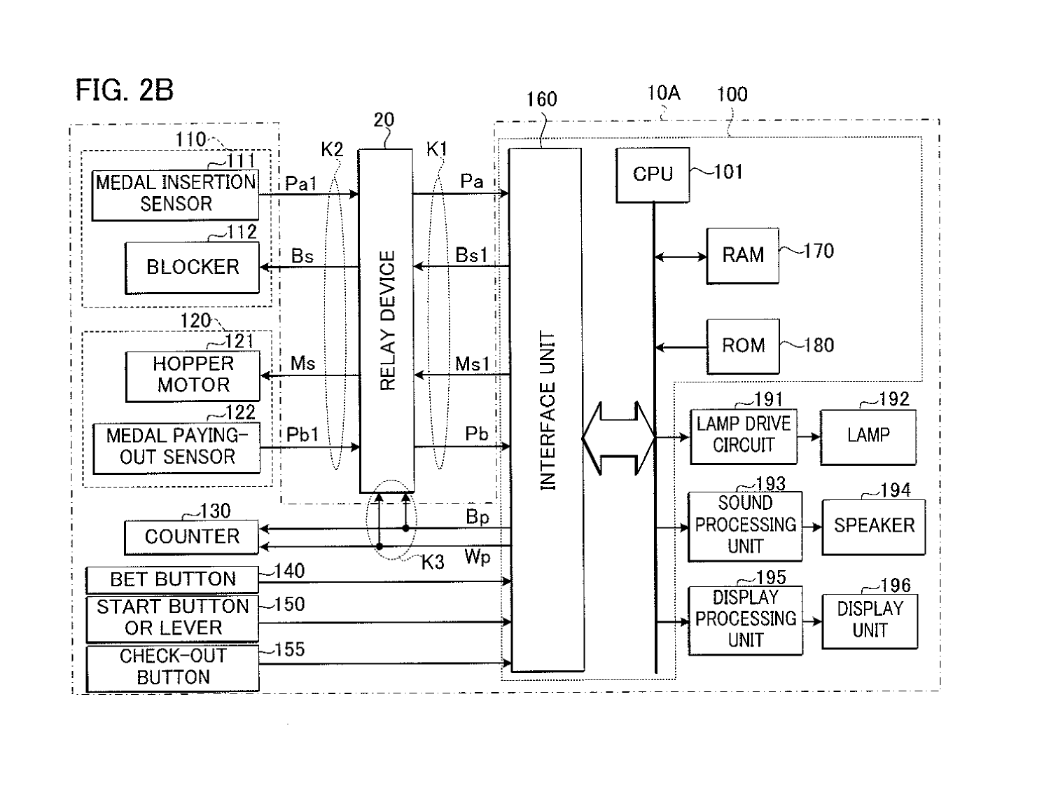

FIG. 2A is a perspective view of the game device 10A. The game device 10A in this example is a slot machine. Similarly to the conventional slot machine, the game device 10A includes a medal insertion port 102, a bet button 140, a start button or lever 150, a left stop button 151, a center stop button 152, a right stop button 153, a check-out button 155, an illumination lamp 192, a speaker 194, a display unit 196, a medal discharge port 161, and a medal tray 162.

FIG. 2B shows the structure of the game device 10A. When the player inserts the medals into the medal insertion port 102 (FIG. 2A), the number of the inserted medals is counted and stored as the credit. When the player operates the bet button 140, the number corresponding to the operation is subtracted from the owned credit, and the subtracted credit is bet. When the player operates the start button or lever 150 after that, the lottery is executed. According to the result of the lottery, video reels displayed on the display unit 196 are controlled to rotate or stop. In this case, when the reels stop with a combination of predetermined symbols, the player wins a prize and is given the medals whose number corresponds to the stopped symbols. Specifically, the credit number increases.

The game device 10A includes a main body board 100, a medal selector 110, a medal hopper 120, a counter 130, the bet button 140, the start button or lever 150, and the check-out button 155. The main body board 100 and other components are connected with cables. According to this embodiment, the later-described relay device 20 is provided between the main body board 100 and the medal selector 110, the medal hopper 120, and the counter 130. Specifically, instead of the cables connecting between the main body board 100 and the medal selector 110 and the medal hopper 120, the main body board 100 is connected with the relay device 20 via a first cable K1, the relay device 20 is connected with the medal selector 110 and the medal hopper 120 via second cables K2, and the relay device 20 is connected to a cable between the main body board 100 and the counter 130 via a third cable.

The medal selector 110 includes a medal insertion sensor 111 and a blocker 112. The medal selector 110 is provided between the medal hopper 120 that stores the medals to be paid out and the medal insertion port 102. The blocker 112 is structured to acquire the inserted medals into the device (the medal hopper 120 in the game device) when a discharge signal Bs is active (high level), and discharge the inserted medals out of the device (out of the game device) when the discharge signal Bs is not active (low level). The discharge signal Bs is generated in the relay device 20, and activated at least when a normal discharge signal Bs1 outputted from the main body board 100 is active. An input terminal of the blocker 112 functions as a second input unit to which at least the normal discharge signal Bs1 is supplied. In this specification, the signal, generated in the game device to control whether to acquire or discharge the medals inserted from the medal insertion port into or out of the device, is referred to as the “normal discharge signal” Bs1. Supposing that the relay device 20 is not connected to the game device, the normal discharge signal Bs1 causes the blocker 112 of the game device to operate, similarly to the discharge signal Bs.

The medal insertion sensor 111 lies downstream of the blocker 112 in a medal path from the medal insertion port 102 to the medal hopper 120, and detects the medals passing through the blocker 112 to generate normal medal detection pulses Pa1. In this specification, the pulses generated in the game device in response to the detected medals are referred to as the “normal medal detection pulses” Pa1. Supposing that the relay device 20 is not connected to the game device, a CPU 101 of the game device increases the credit number according to the normal medal detection pulses Pa1. An output terminal of the medal insertion sensor 111 functions as a first output unit that detects the medals inserted from the medal insertion port 102 and outputs the normal medal detection pulses Pa1. Further, the blocker 112 functions as a discharge unit that controls the medal insertion sensor 111 to detect the inserted medals and acquire the medals in the device, or not to detect the inserted medals and discharge the medals out of the device, according to the discharge signal Bs.

The medal hopper 120 includes a hopper motor 121 and operates when the stored medals are paid out to the medal discharge port 161. A drive signal Ms is supplied to the hopper motor 121. The hopper motor 121 operates when the drive signal Ms is at the high level, and the hopper motor 121 stops its operation when the drive signal Ms is at the low level. A medal paying-out sensor 122 detects the paid-out medals to generate normal medal paying-out pulses Pb1. In this specification, the pulses generated in response to the detected medals paid out from the medal hopper 120 of the game device are referred to as the “normal medal paying-out pulses” Pb1. Supposing that the relay device 20 is not connected to the game device, the CPU 101 of the game device counts the normal medal paying-out pulses Pb1 and, when the number of counts reaches the number of the medals to be paid out (the credit number held in the game device 10A), the CPU 101 of the game device causes a later-described normal drive signal Ms1 to be the low level in order to stop the hopper motor 121. Further, the CPU 101 reduces the credit number held in the game device by the number of counts.

The counter 130 is formed by a magnetic counter (bet counter) that counts and displays the number of the bet medals, and a magnetic counter (win counter) that counts and displays the number of the won medals (the number of the medals given in reward for the result of the game). When a bet is placed on the game, the main body board 100 supplies a bet pulse Bp to the bet counter to make the bet counter count up, and when a win is generated (the medals are given) as a result of the game, the main body board 100 supplies a win pulse Wp to the win counter to make the win counter count up. When the game device 10A is not connected to the relay device 20, it is necessary for an employee to open a door attached to a housing of the game device 10A, check the number of the wins and the number of the bets displayed on the counter 130, and totalize the numbers for the entire amusement facility after close of business, so as to understand operating status of the game devices on a daily basis. Further, it is not possible to subject the game device 10A that is not connected to the relay device 20 to the jackpot lottery because the number of the bet medals to the game device 10A and the number of the won (given) medals in the game device 10A cannot be recognized by the management device 30. Such problems are solved when the game device 10A is connected to the relay device 20.

The main body board 100 includes the CPU 101 that controls the game device as a whole, an interface unit 160, RAM 170 that functions as a working space of the CPU 101, and ROM 180 that stores a control program and the like. Further, the game device 10A includes the illumination lamp 192, a lamp drive circuit 191 that supplies a lamp drive signal to the lamp192 under the control of the CPU 101, the speaker 194 that outputs sound effects and sounds to navigate the player, a sound processing unit 193 that supplies a speaker drive signal to the speaker 194 under the control of the CPU 101, the display unit 196 that displays the video reels and the like, and a display processing unit 195 that supplies an image signal to the display unit 196 under the control of the CPU 101.

The interface unit 160 outputs the normal discharge signal Bs1, the bet pulse Bp, the win pulse Wp, and also the normal drive signal Ms1 that gives an instruction to start or stop the operation of the hopper motor 121, under the control of the CPU 101. In this specification, the signal generated in the game device to start or stop the operation of the hopper motor 121 is referred to as the “normal drive signal” Ms1. Supposing that the relay device 20 is not connected to the game device, the normal drive signal Ms1 controls the operation of the hopper motor 121 in the game device, similarly to the drive signal Ms. The normal drive signal Ms1 gives an instruction to operate the hopper motor 121 when it is at the high level, and gives an instruction to stop the operation of the hopper motor 121 when it is at the low level. Further, medal detection pulses Pa are supplied instead of the normal medal detection pulses Pa1, and medal paying-out pulses Pb are supplied instead of the normal medal paying-out pulses Pb1 from the relay device 20 to the interface unit 160.

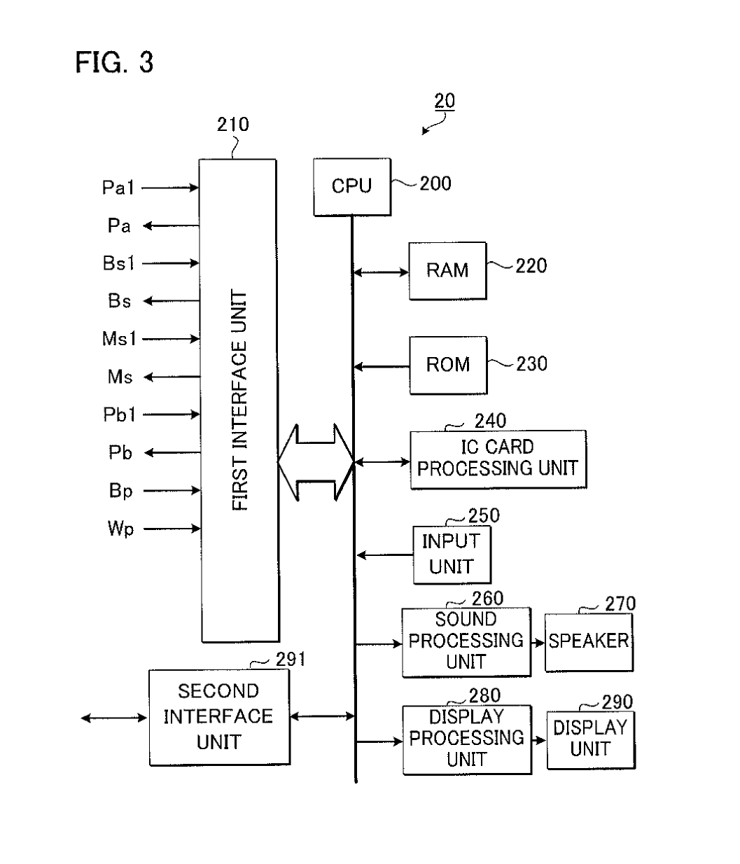

FIG. 3 shows the structure of the relay device 20. The relay device 20 includes a CPU 200 that controls the relay device as a whole, a first interface unit 210 that communicates with the game device 10A, RAM 220 that functions as a working space of the CPU 200, and ROM 230 that stores a control program and the like. Further, the relay device 20 includes an IC card processing unit 240 that can read information from an IC card, an input unit 250 that allows the player to input an instruction, a speaker 270 that outputs sound effects and sounds to navigate the player, a sound processing unit 260 that supplies a drive signal to the speaker 270 under the control of the CPU 200, a display unit 290 that displays an image, a display processing unit 280 that supplies an image signal to the display unit 290 under the control of the CPU 200, and a second interface unit 291 that communicates with the management device 30 and the medal storage device 40. Player identification information stored in the IC card is used to identify the player for personal authentication, so that the IC card is used to deposit and withdraw the credit number to and from the medal storage device 40, to update user data, or to understand an operating condition of the game device 10A in the management device 30. The second interface unit 291 communicates with the external devices such as the management device 30, the medal storage device 40 and the like either through the wires or wirelessly. Known technology such as a cable LAN, Wi-Fi and the like may be employed.

As described above, the management device 30 executes the jackpot lottery targeting the game devices whose players are participating in the game. The management device 30 transmits an increase instruction for increasing the credit to the winning game device. Sometimes, the medal storage device 40 pays out the stored credit according to the instruction from the player (transfers the credit from the medal storage device 40 to the game device). In this case, the medal storage device 40 transmits the increase instruction to the game device. It should be noted that the game device 10A in itself does not have the function of receiving the increase instruction from the outside. However, when the medal detection pulses Pa are inputted into the interface unit 160 of the game device 10A, the game device 10A construes that the medals are inserted therein and increases the credit number. The relay device 20 uses this and, when receiving the increase instruction from the management device 30 or the medal storage device 40, supplies the medal detection pulses Pa that correspond to the credit number shown by the increase instruction to the game device 10A, so as to increase the credit number in the game device 10A. Hereinafter, the operation of the relay device 20 when receiving the instruction of the credit increase will be explained.

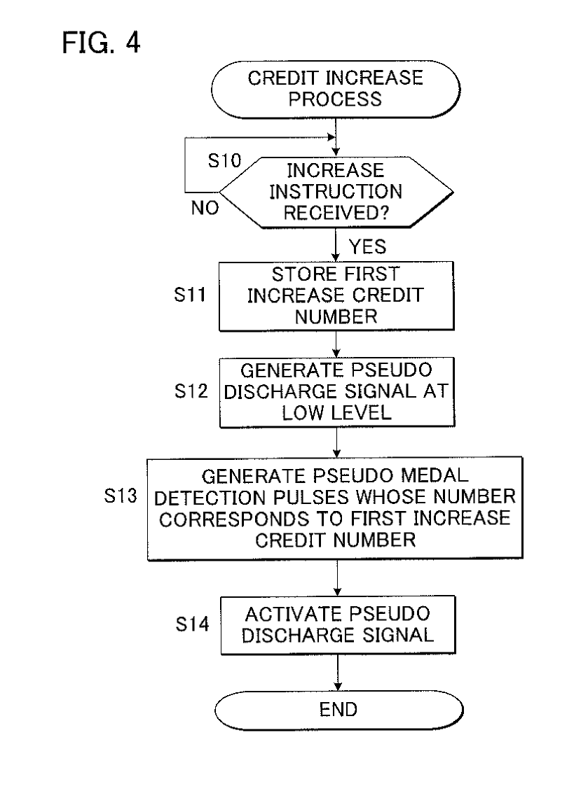

FIG. 4 shows a flowchart of the operation of the CPU 200 when accepting the increase instruction. First, the CPU 200 determines whether the increase instruction is received or not (step S10) and, when it is received, stores in the RAM 220 a first increase credit number as the credit number to be increased shown in the increase instruction (step S11). Next, the CPU 200 generates a pseudo discharge signal Bs2 that gives an instruction to discharge the inserted medals out of the device, and outputs the signal to the first interface unit 210 (step S12). In this specification, the signal that is generated in the relay device 20 receiving the increase instruction and that is to discharge the medals inserted from the medal insertion port out of the device is referred to as the “pseudo discharge signal” Bs2.

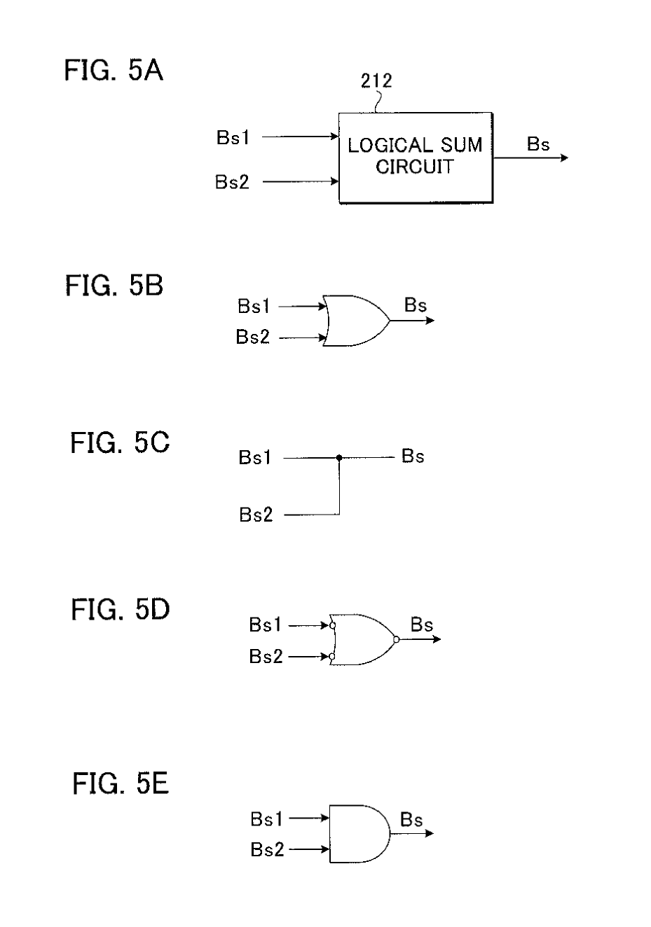

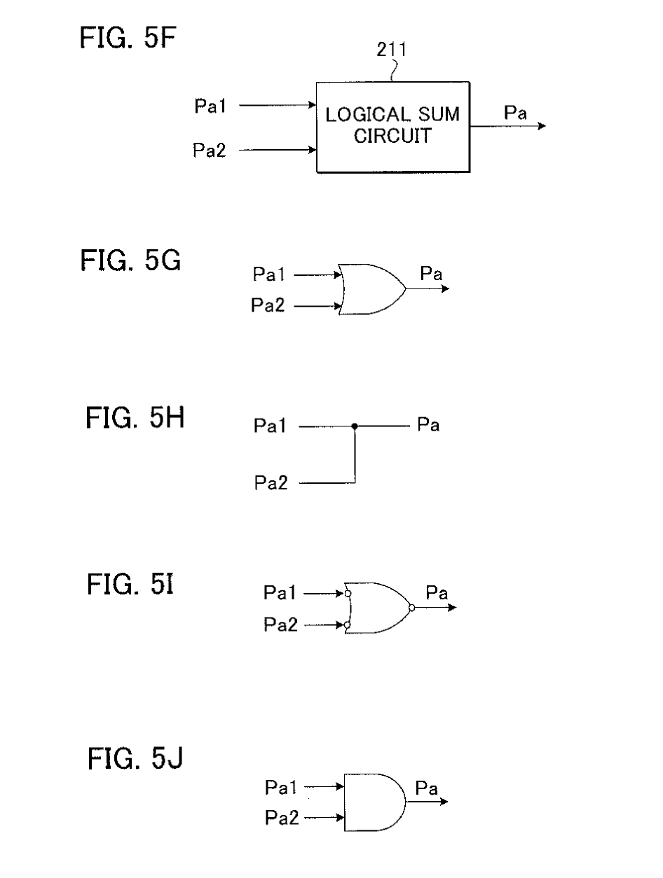

The first interface unit 210 includes a logical sum circuit 212 that implements logical sum operation between the normal discharge signal Bs1 and the pseudo discharge signal Bs2 to generate the discharge signal Bs, as shown in FIG. 5A. This logical sum circuit 212 may be formed by an OR circuit shown in FIG. 5B or a wired-OR connection shown in FIG. 5C, in case in which the normal discharge signal Bs1 is in positive logic. The logical sum circuit 212 may be formed by an AND circuit shown in FIG. 5D, in case in which the normal discharge signal Bs1 is in negative logic. This AND circuit may be represented as shown in FIG. 5E. Thus-generated discharge signal Bs is outputted from an output terminal (second relay output unit) of the first interface unit 210 to the input terminal (second input unit) of the blocker 112. With such a structure, the blocker 112 discharges the medals out of the device in either or both of the case when the CPU 101 of the game device 10A gives an instruction to discharge the medals inserted from the medal insertion port out of the device, and the case when the relay device 20 receives the increase instruction.

After step S12, the CPU 200 generates pseudo medal detection pulses Pa2 whose number corresponds to the first increase credit number, and outputs these to the first interface unit 210 (step S13). In this specification, the pulses generated in the relay device 20 to increase the credit number in the CPU 101 of the game device are referred to as the “pseudo medal detection pulses” Pa2. The first interface unit 210 includes a logical sum circuit 211 that implements the logical sum operation between the normal medal detection pulses Pa1 and the pseudo medal detection pulses Pa2 to generate the medal detection pulses Pa. As shown in FIG. 5F, this logical sum circuit 211 is structured similarly to the logical sum circuit 212 in FIG. 5A. This logical sum circuit 211 may be formed by an OR circuit shown in FIG. 5G or a wired-OR connection shown in FIG. 5H, in case in which the normal medal detection pulses Pa1 are in positive logic. The logical sum circuit 211 may be formed by an AND circuit as shown in FIG. 5I, in case in which the normal medal detection pulses Pa1 are in negative logic. This AND circuit may be represented as shown in FIG. 5J. With such a structure, when the normal medal detection pulses Pa1 or the pseudo medal detection pulses Pa2 are generated, the game device 10 increases the credit number.

After step S13, the CPU 200 activates the pseudo discharge signal Bs2 after the generation of the pseudo medal detection pulses Pa2, whose number corresponds to the first increase credit number, is completed (step S14).

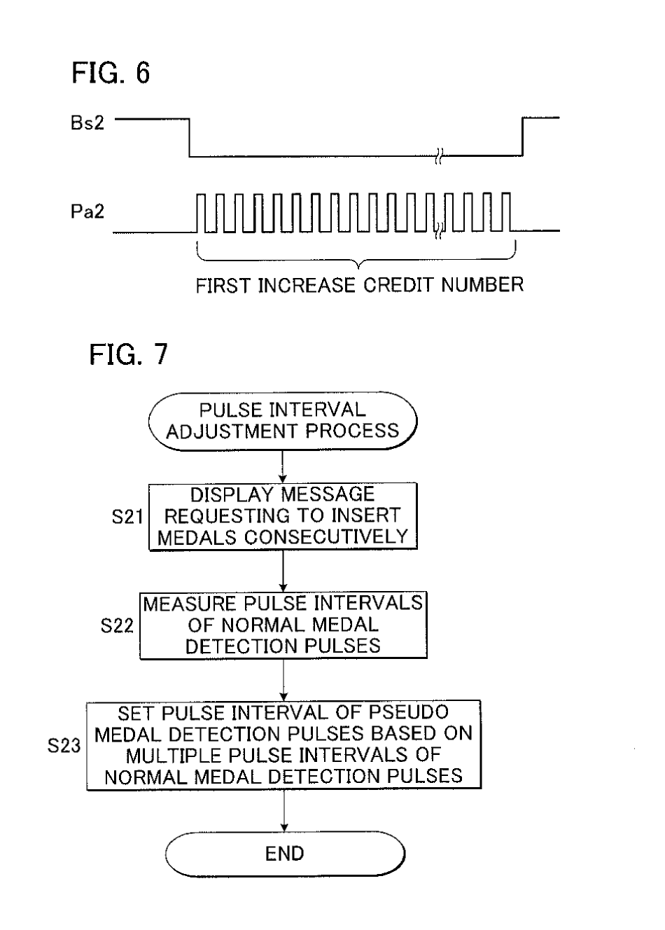

FIG. 6 shows the relationship between the pseudo discharge signal Bs2 and the pseudo medal detection pulses Pa2. When the Steps S12, S13 and S14 are performed as described above, the pseudo discharge signal Bs2 is deactivated before the pseudo medal detection pulses Pa2 are generated, and activated after the generation of the pseudo medal detection pulses Pa2 is completed. Thus, the blocker 112 operates to discharge the medals that are inserted in the medal insertion port 102 by the player out of the device, during the period when the pseudo medal detection pulses Pa2 are generated, and hence the normal medal detection pulses Pa1 are not generated by the medal insertion sensor 111. This makes it possible to prevent a conflict between (simultaneous occurrence of) the normal medal detection pulses Pa1 and the pseudo medal detection pulses Pa2, and to prevent either of the pulses from being ignored. It is possible for the game device 10A to increase the credit number by the number corresponding to the first increase credit number, without making the pseudo medal detection pulses Pa2 and the normal medal detection pulses Pa1 conflict with each other.

Next, a method of setting pulse intervals of the pseudo medal detection pulses Pa2 will be explained. The medal insertion sensor 111 generates the normal medal detection pulse Pa1 every time the medal passes through a predetermined position of the path. The intervals of the normal medal detection pulses Pa1 when the medals are inserted consecutively vary depending on a type of the medal to be used, an angle of the path, and the like. The type of the medal may differ from one amusement facility to another, and the angle of the path may differ according to the model of the game device 10A. When the intervals of the pseudo medal detection pulses Pa2 generated in the relay device 20 are extremely smaller than the intervals of the normal medal detection pulses Pa1 that are generated in the game device 10A to cause the CPU 101 of the game device to increase the credit number when the relay device 20 is not connected to the game device, the game device 10A may malfunction or judge the condition to be abnormal to perform an error process. Therefore, it is desirable that the intervals of the pseudo medal detection pulses Pa2 are independently set for each of the medals to be used and for each of the game devices 10A.

For this reason, the CPU 200 performs a pulse interval adjustment process to set the pulse intervals of the pseudo medal detection pulses Pa2. FIG. 7 shows a flowchart of the pulse interval adjustment process. First, the CPU 200 causes the display unit 290 to display a message requesting the player to insert the medals consecutively (step S21). For example, such a message that “Please insert 20 medals consecutively.” is displayed on the display unit 290.

Next, the CPU 200 measures the pulse intervals of a plurality of normal medal detection pulses Pa1 generated by the consecutive insertion of the medals (step S22). In this case, the CPU 200 detects a time from a falling edge of one normal medal detection pulse Pa1 to a rising edge of the next normal medal detection pulse Pa1, a time from a rising edge of one normal medal detection pulse Pa1 to a falling edge of the next normal medal detection pulse Pa1, a time from the falling edge of one normal medal detection pulse Pa1 to a falling edge of the next normal medal detection pulse Pa1, or a time from a rising edge of one normal medal detection pulse Pa1 to a rising edge of the next normal medal detection pulse Pa1, as the pulse interval of the normal medal detection pulses Pa1.

Next, based on the plurality of pulse intervals of the normal medal detection pulses Pa1 that are measured, the CPU 200 sets the pulse interval of the pseudo medal detection pulses Pa2. Specifically, the pulse interval of the pseudo medal detection pulses Pa2 is set in such a manner that the interval is equal to or larger than the minimum pulse interval among the plurality of pulse intervals of the normal medal detection pulses Pa1 that are measured. In this case, the plurality of pulse intervals may be compared with each other to identify the minimum pulse interval, and the identified minimum pulse interval or a time with a predetermined time added thereto may be set as the pulse interval of the pseudo medal detection pulses Pa2. Alternatively, a period of time that is included in a time range from the minimum pulse interval to the maximum pulse interval may be set as the pulse interval of the pseudo medal detection pulses Pa2. Also, an average value of the plurality of pulse intervals may be set as the pulse interval of the pseudo medal detection pulses Pa2. In every case, the pulse interval of the pseudo medal detection pulses Pa2 is set to be equal to or greater than the minimum pulse interval among the plurality of pulse intervals of the normal medal detection pulses Pa1. Alternatively, when the minimum pulse interval is larger than a predetermined interval that is stored in advance, it is determined that the consecutive insertion is not made properly. In this case, it is possible to set the predetermined interval as the pulse interval of the pseudo medal detection pulses Pa2, or to encourage the consecutive insertion of the medals once again.

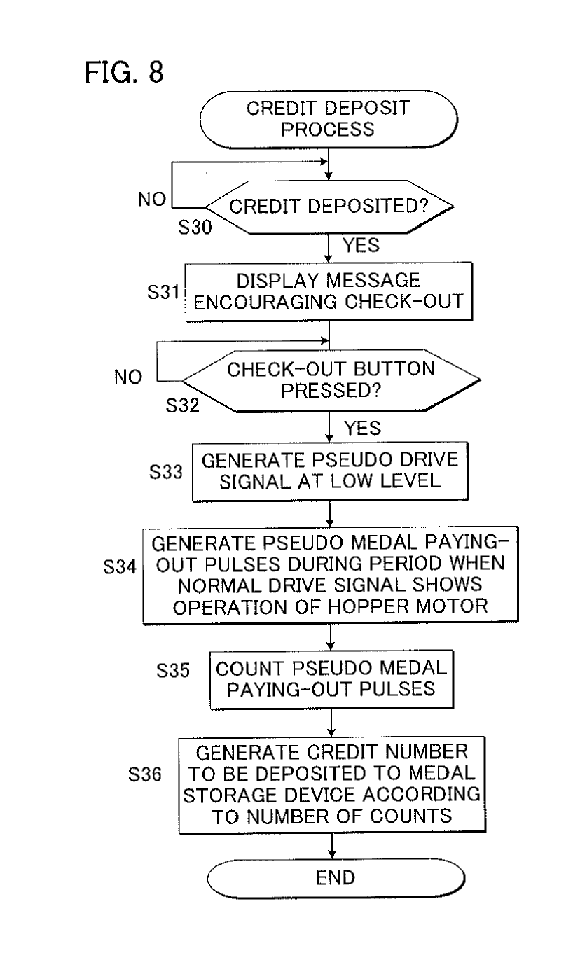

Next, a deposit process to deposit the credit that is held in the game device 10A to the medal storage device 40 will be explained. FIG. 8 shows the contents of the credit deposit process. First, the CPU 200 determines whether or not the player selects to deposit the credit by operating the input unit 250 (step S30) and, when the player selects the deposit, causes the display unit 290 to display a message encouraging check-out to the player (step S31). The message includes, for example, “Please press the check-out button.” or the like.

When determining that the check-out button 155 is pressed by the player (step S32), the CPU 200 generates a pseudo drive signal Ms2 that gives an instruction to stop the operation of the hopper motor 121 (step S33). In this specification, the signal that is generated in the relay device 20 to stop the operation of the hopper motor 121 is referred to as the “pseudo drive signal” Ms2. At this time, the pseudo drive signal Ms2 gives an instruction to operate the hopper motor 121 when it is at the high level, and gives an instruction to stop the operation of the hopper motor 121 when it is at the low level, similarly to the normal drive signal Ms1. However, the pseudo drive signal Ms2 has to be at the low level because it is used only for the purpose of stopping the operation of the hopper motor 121. When the check-out button 155 is pressed by the player, the CPU 101 of the game device 10A generates the normal drive signal Ms1 at the high level for operating the hopper motor 121. In the determination of the step S32, it is possible for the CPU 200 to determine that the check-out button 155 is pressed when the normal drive signal Ms1 at the high level is started to be supplied from the interface unit 160 of the game device 10A.

When the player presses the check-out button 155 by operating the input unit 250 of the relay device 20 without selecting to deposit the credit (step S30), the first interface unit 210 of the relay device 20 supplies the normal drive signal Ms1 at the high level, generated in the game device 10A and supplied from the interface unit 160 as the check-out button 155 is pressed, to the hopper motor 121 as the drive signal Ms. The hopper motor 121 is operated by this and the medals are paid out to the medal discharge port 161. Further, when the relay device 20 is not connected to the game device 10A, the player does not select to deposit the credit (step S30) by the operation into the input unit 250 of the relay device 20. When the player presses the check-out button 155, the normal drive signal Ms1 at the high level is supplied to the hopper motor 121 and the medals are paid out to the medal discharge port 161.

In the credit deposit process, on the other hand, the first interface unit 210 of the relay device 20 supplies the pseudo drive signal Ms2, instead of the normal drive signal Ms1, to the hopper motor 121 as the drive signal Ms. Thereby, the hopper motor 121 is not operated and the medals are not paid out to the medal discharge port 161.

The CPU 200 of the relay device 20 monitors the normal drive signal Ms1 and generates pseudo medal paying-out pulses Pb2 during a period when the level of the normal drive signal Ms1 is at the high level (that is, a period when the CPU 101 of the game device gives an instruction to operate the hopper motor 121) (step S34). In this specification, the pulses that are generated in the relay device 20 and that causes the CPU 101 of the game device to recognize as if the medals were paid out by the medal hopper 120 of the game device are referred to as the “pseudo medal paying-out pulses” Pb2. At this time, the first interface unit 210 implements the logical sum operation between the pseudo medal paying-out pulses Pb2 and the normal medal paying-out pulses Pb1, to supply the medal paying-out pulses Pb to the game device 10A. In the credit deposit process, the hopper motor 121 is not operated even when the normal drive signal Ms1 is at the high level, and the normal medal paying-out pulses Pb1 are not generated. However, as the pseudo medal paying-out pulses Pb2 are generated in the step S34, the medal paying-out pulses Pb are supplied to the CPU 101 of the game device 10A. The medal paying-out pulses Pb are counted in the CPU 101 and, when the number of counts reaches the credit number held in the game device 10A, the CPU 101 of the game device causes the normal drive signal Ms1 to be the low level. Further, the CPU 101 reduces the credit number held in the game device by the number of counts.

Although the game device 10A generates the normal drive signal Ms1 at the high level in order to operate the hopper motor 121 during this period, the drive signal Ms at the low level is supplied to the game device 10A because the pseudo drive signal Ms2 is at the low level.

Therefore, even when the player presses the check-out button 155, the hopper motor 121 is not operated and the medals are not paid out of the device. Meanwhile, the pseudo medal paying-out pulses Pb2 are generated. As the game device 10A in itself generates the normal drive signal Ms1 to operate the hopper motor 121 and pay out the medals, the game device 10A accepts and processes the supplied medal paying-out pulses Pb appropriately. As a result of this, the held credit number is reduced even though the medals are not paid out.

Next, the CPU 200 of the relay device 20 counts the pseudo medal paying-out pulses Pb2 (step S35). The credit number in the game device 10A is reduced by the number of the pseudo medal paying-out pulses Pb2. When the credit number in the game device 10A is eventually reduced to zero, the game device 10A causes the normal drive signal Ms1 to be the low level. In the processing of step S34, the CPU 200 generates the pseudo medal paying-out pulses Pb2 during the period when the normal drive signal Ms1 is at the high level, but the CPU 200 stops the generation of the pseudo medal paying-out pulses Pb2 when the credit number in the game device 10A is reduced to zero and the normal drive signal Ms1 becomes the low level. Consequently, the pseudo medal paying-out pulses Pb2, whose number is the same as the credit number held in the game device 10A, are generated.

Then, the CPU 200 counts the pseudo medal paying-out pulses Pb2 (step S35), and generates a deposit credit number that is the number of counts at the time when the normal drive signal Ms1 changes from the high level to the low level (step S36). Thus-generated deposit credit number is transmitted to the medal storage device 40 together with the identification information for identifying the player.

Thus, according to this embodiment, when electronically storing (transferring) the deposit credit number that shows the credit number held in the game device 10A into the medal storage device 40, the pseudo drive signal Ms2 that gives an instruction to stop the hopper motor 121 is supplied as the drive signal Ms to the hopper motor 121, instead of the normal drive signal Ms1 that gives an instruction to operate the hopper motor 121. At the same time, the pseudo medal paying-out pulses Pb2 are generated, although the medals are not actually paid out, and the medal paying-out pulses Pb are supplied to the interface unit 160 of the game device 10A. As the game device 10A in itself generates the normal drive signal Ms1 to operate the hopper motor 121 and pay out the medals, the game device 10A accepts and processes the supplied medal paying-out pulses Pb appropriately. As a result of this, it is possible to reduce the held credit number by the number of the pseudo medal paying-out pulses Pb2, even though the medals are not paid out of the device.

As described thus far, the management device 30 executes the jackpot lottery. The lottery is targeted for the game devices 10A and 10B whose players are participating in the game. The participation in the game means that the medals are bet to execute the game, or that the medals are given by winning the game. For this reason, the relay device 20 transfers the bet pulse Bp and the win pulse Wp to the management device 30. The management device 30 executes the jackpot lottery targeted for the game devices 10A and 10B transmitting the bet pulse Bp or the win pulse Wp.

Some players may use a plurality of game devices 10A concurrently and reduce the frequency of playing the game in the game devices 10A other than the mainly-played game device 10A, so as to receive benefits from the jackpot lottery. In order to eliminate the game devices 10A that are played by the same player concurrently from the jackpot lottery, the CPU 200 of the relay device 20 may cause the IC card processing unit (reading unit) to periodically read out the identification information that is recorded in the IC card, and may transmit the bet pulse Bp to the management device 30 only during the period when the identification information can be read out. That is, the relay device 20 may generate pseudo bet information or pseudo win information showing the extent of participation in the game, based on the identification information read out from the IC card, the bet pulse Bp or the win pulse Wp, and may transmit the information to the management device 30. Thus, the game device 10A that is not played by using the IC card can be eliminated from the jackpot lottery, so that the concurrent playing by the same player can be prevented. The relay device 20 may generate the information showing the extent of participation in the game based only on the identification information read out from the IC card, and may transmit the information to the management device 30.

According to this embodiment as described thus far, it is possible to connect the game device 10A, not having the interface with the management device 30 and the medal storage device 40, to the management device 30 and the medal storage device 40. This makes it possible to transfer the credit from the external devices to the game device 10A, and to transfer the credit from the game device 10A to the external devices. Further, it is also possible to subject the game devices 10A to the jackpot lottery. Consequently, it is possible to collectively deal with the game devices 10B, each of which has the interface with the external devices, and the game device 10A, each of which does not have the interface, even when these are provided in a mixed manner.

The present invention is not limited to the above-described embodiment and following modifications can be made, for example. One or more aspects that are selected freely from the following exemplifications can be combined as necessary.

(1) According to the above-described embodiment, the first increase credit number is added to the credit in the game device 10A without any change. However, the player may use the input unit 250 and input an acquisition credit number as a credit number to be acquired in the game device 10A out of the first increase credit number. In this case, the player uses the input unit 250 to input an acquisition instruction to acquire the acquisition credit number into the game device 10A. After sensing the acquisition instruction, the CPU 200 obtains a new first increase credit number by subtracting the acquisition credit number from the first increase credit number, and updates the contents stored in the RAM 220. After the pseudo discharge signal Bs2 is generated, the CPU 220 generates the pseudo medal detection pulses Pa2 whose number corresponds to the acquisition credit number. In this case, the first interface unit implements the logical sum operation between the normal medal detection pulses Pa1 and the pseudo medal detection pulses Pa2, and supplies thus-obtained medal detection pulses Pa to the game device 10A.

When winning the jackpot according to this modification example, for example, it is not necessary to acquire all of the first increase credit number in the game device 10A. A part of the first increase credit number can be acquired in the game device 10A, and the remaining can be held in the credit of the relay device.

(2) The relay device 20 according to the above-described embodiment generates the pseudo medal detection pulses Pa2, whose number corresponds to the first increase credit number specified in the increase instruction, and supplies these to the game device 10A as the medal detection pulses Pa. The present invention is not limited to the above, and the CPU 200 may not only store the first increase credit number shown by the increase instruction in the RAM 220, but also count the normal medal detection pulses Pa1 and store the result of the counting in the RAM 220 as a second increase credit number. When receiving the increase instruction from the external devices, the CPU 200 may generate the pseudo discharge signal Bs2, thereafter generate the pseudo medal detection pulses Pa2, whose number corresponds to the first increase credit number and the second increase credit number, and output these to the game device 10A as the medal detection pulses Pa.

In this case, when the medals are inserted by the player in the medal insertion port 102, the relay device 20 counts the normal medal detection pulses Pa1, generates the second increase credit number, and stores the number in the RAM 220. Thus, it is possible to deal with the first increase credit number and the second increase credit number in a similar manner. In the modification example, it is not necessary to provide the logical sum circuit 211 that implements the logical sum operation between the normal medal detection pulses Pa1 and the pseudo medal detection pulses Pa2 in the first interface unit 210. However, the discharge signal Bs may be generated by the logical sum circuit 212 that implements the logical sum operation between the normal discharge signal Bs1 and the pseudo discharge signal Bs2.

Further, the player may use the input unit 250 to input the acquisition credit number as the credit number to be acquired from the relay device 20 to the game device 10A, and the acquisition instruction to acquire the acquisition credit number to the game device 10A. In this case, the CPU 101 may calculate the sum of the first increase credit number and the second increase credit number and may store the result as an increase credit number in the RAM 220, instead of storing the first increase credit number and the second increase credit number in the RAM 220. In this case, after the acquisition instruction is inputted, the acquisition credit number is subtracted from the increase credit number to obtain a new increase credit number, and the contents stored in the RAM 220 are updated. Then, after the pseudo discharge signal Bs2 is generated, the pseudo medal detection pulses Pa2, whose number corresponds to the acquisition credit number, may be generated and supplied to the game device 10A as the medal detection pulses Pa. Further, such structure may be employed that the instruction on the acquisition credit number and the acquisition instruction can be made by one input, like, for example, a predetermined credit number is acquired from the relay device 20 into the game device 10A by pressing a button showing a predetermined credit number. In this case, an acquisition credit number input unit and an acquisition instruction unit are formed as one unit.

(3) The above-described game device 10A generates the bet pulse Bp and the win pulse Wp in order to increase the counter values of the magnetic counter (bet counter) that counts and displays the number of the bet medals, and the magnetic counter (win counter) that counts and displays the number of the won medals (the number of the medals given as a result of the game). However, some game devices do not generate the bet pulse Bp or the win pulse Wp (the game device not having the magnetic counters and the like). In this case, the CPU 200 or the first interface unit 210 of the relay device 20 may function as a monitor unit to monitor a control signal controlling the element in the game device, and may transmit to the management device 30 the monitored control signal, or the pseudo bet information or the pseudo win information generated based on the monitored control signal and showing that the player is participating in the game.

The above-described bet pulse Bp is one of the control signals, but the following signals may be exemplified as other control signals.

Firstly, signals outputted from various buttons or levers may be used as the control signals. For example, the start button or lever 150 or a button to give an instruction to bet and start the game may be used. When the number of the bet medals is constant in the game, the number may be used as the pseudo bet information. Even when the number of the bet medals is not constant, the determination can be made that at least one bet is placed, which can be used as the pseudo bet information.

Secondly, an output signal from the lamp drive circuit 191 may be used as the control signal. For example, the lamp drive signal to drive the lamp in order to inform the player of status of the game, including the winning of the game, bets, wins, start of the game and the like, may be used. When the win is generated and when the game is executed, the determination can be made that some kind of bet is conducted on the game, which can be used as the pseudo bet information.

Thirdly, when the bet button or the start button is formed by a touch panel that is also used as the display unit 196, the control signal showing contact on the touch panel may be used. In this case, it is not possible to identify the button pressed by the player unless specialized software is used, but a signal obtained by sensing the contact that is outputted from the hardware may be used.

Fourthly, when the game progresses by using the mechanism such as the mechanical reels and the like in the game device, the control signal to drive the reel mechanism may be used. The rotation of the reels means that the game is being executed, and the determination can be made that some kind of bet is placed on the game. This can be used as the pseudo bet information.

Fifthly, when the credit is displayed on the predetermined display device (a display device of seven segments, for example), the control signal to the display device may be used. In this case, as the increase or decrease of the credit number can be sensed by monitoring the control signal, it is possible to recognize whether the player places a bet or not, the number of the bet medals and the like.

Lastly, the participation in the game may be assumed based on the insertion of the medals or the paying-out of the medals. For example, the normal medal detection pulses Pa1 (normal medal paying-out pulses Pb1), or a signal used in medal paying-out operation from the medal storage device 40 may be used as the control signal. Further, a predetermined period, from the insertion of the medals or the paying-out of the medals of a predetermined number or more, may be determined as the period when the player is participating in the game. In this case, the determination process may be executed either in the relay device 20 or in the management device 30.

As described in the above-described modification example, when the first increase credit number regarding the increase instruction is stored in the RAM 220, and the specified acquisition credit number is transferred from the first increase credit number held in the relay device to the game device 10A by the operation of the input unit by the player, it is preferable that an upper limit is set on the acquisition credit number. When a small number of the upper limit is set (for example, 50 medals or less, or the number of the medals capable of executing the 10 games or less), frequency of operating the input unit 250 is increased in order for the player to place bets and continue the game. Thus, accuracy in determining the participation in the game (determination of the number of the bets made during the predetermined period) can be improved.

(4) Moreover, a human detection sensor may be provided on a seat so as to sense whether the player is seated or not. The sensor that reacts with infrared radiation emitted from the human may be employed as the human detection sensor. Alternatively, a camera may be attached to the relay device 20 so as to determine the existence of the player. In this case, image analysis may be made to determine whether a person is seated or not. These seating information may be transmitted from the relay device 20 to the management device 30. When the seating information of the player is used together with the above-described various control signals showing the bets and wins, it is possible to improve reliability of the generated pseudo bet information.

(5) Further, supposing that the player is participating in the game in a certain period after a participation button that is provided to the relay device 20 is pressed, the participation in the game may be determined by allowing the player to press the participation button periodically. In this case, when the participation button is not pressed again after the certain period from when the participation button is pressed, it can be determined that the player is not participating in the game until the button is pressed next.

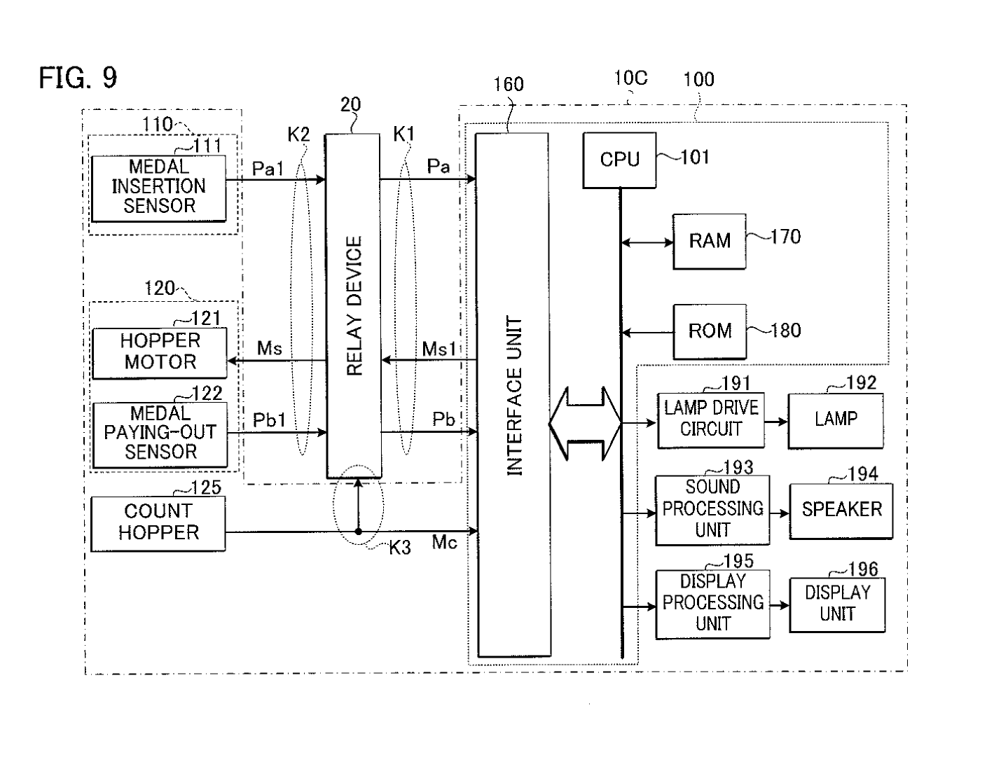

(6) Furthermore, when the game device is the so-called pusher game device 10C, the relay device 20 may be formed as shown in FIG. 9. According to the pusher game device 10C, the medals are inserted from the medal insertion port into a field by using a rail. As edges of the field include an effective end and an ineffective end, the medals dropped from the ineffective end are collected in the pusher game device 10C, and the medals dropped from the effective end are paid out to the player. A pusher that slides toward the effective end is provided in the field. The player takes good aim and inserts the medal so that the medals drop from the effective end, according to the movement of the pusher.

In the pusher game device 10C, the medals inserted from the medal insertion port are inserted into the field directly to be used in the game, and therefore the blocker 112 is not provided. For this reason, the number of the medals inserted from the medal insertion port can be regarded as the number of the medals bet on the game and can be used in the jackpot lottery and the like. The medal hopper 120 is used to pay out the medals stored in the medal storage device 40. A count hopper 125 is a hopper for paying out the medals dropped from the effective end. When the medals drop from the effective end, a motor operates automatically and the medals are paid out of the device. The count hopper 125 is equipped with a sensor for detecting the medals to be paid out and outputting medal count pulses Mc.

When receiving the increase instruction, the relay device 20 generates the pseudo drive signal Ms2 that causes the hopper motor 121 to operate until the number of the normal medal paying-out pulses Pb1 reaches a first increase medal number, and supplies the pseudo drive signal Ms2 to the hopper motor 121 as the drive signal Ms. Thus, it is possible for the pusher game device 10C to withdraw the medals from the medal storage device 40 and to be subjected to the jackpot lottery.

(7) Further, it is not only the jackpot lottery that the management device 30 executes. It is not necessarily required that the number of the medals bet to each game device is recognized, and that the medals to be given is from the cumulative sum of the number corresponding to a part of the number of the medals bet in each game device, as long as the predetermined lottery is executed and the medals are given to the game device selected as a result of the lottery.

(8) According to the game device 10A, the medals are paid out in reward for the result of the game, but tickets (which may be referred to as coupons) may be paid out instead of the medals.

### REFERENCE SIGNS LIST

GS: Game System
10A, 10B: Game Device
10C: Pusher Game Device
20: Relay Device
30: Management Device
40: Medal Storage Device (Credit Storage Device)
100: Main Body Board
101: CPU (Management Unit)
102: Medal Insertion Port
110: Medal Selector
111: Medal Insertion Sensor (First Output Unit)
112: Blocker (Second Input Unit, Discharge Unit)
120: Medal Hopper (Hopper)
121: Hopper Motor (Motor)
122: Medal Paying-Out Sensor
140: Bet Button
160: Interface Unit (First Input Unit, Second Output Unit, Medal Paying-Out Pulse Input Unit)
200: CPU (Instruction Reception Unit, Pseudo Medal Detection Pulse Generation Unit, Pseudo Discharge Signal Generation Unit, Control Unit, Insert Pulse Interval Detection Unit, Motor Control Unit, Pseudo Medal Paying-Out Pulse Generation Unit, Credit Number Transfer Unit, Monitor Unit, Pseudo Game Participation Information Transmission Unit)
210: First Interface Unit (First Relay Output Unit, Second Relay Output Unit, Normal Medal Detection Pulse Input Unit, Medal Paying-Out Pulse Output Unit, Monitor Unit)
220: RAM (Storage Unit)
240: IC Card Processing Unit (Reading Unit)
250: Input Unit (Acquisition Credit Number Input Unit, Acquisition Instruction Unit, Transfer Input Unit),
290: Display Unit
291: Second Interface Unit (Communication Unit)

1. A relay device connected to a game device comprising:
a first output unit adapted to detect medals inserted from a medal insertion port by a medal insertion sensor, and adapted to output normal medal detection pulses;
a first input unit supplied with medal detection pulses;
a credit management unit adapted to count up and manage a credit number corresponding to the medal detection pulses supplied to the first input unit;
a second output unit adapted to output a normal discharge signal that causes the inserted medals to be discharged out of the device;
a second input unit supplied with a discharge signal; and
a discharge unit adapted to discharge the inserted medals out of the device, without causing the medal insertion sensor to detect the inserted medals, according to the discharge signal supplied to the second input unit, the relay device comprising:
a communication unit adapted to communicate with an outside device;
an instruction reception unit adapted to receive an increase instruction that increases the credit number via the communication unit;
a storage unit adapted to store a first increase credit number as the credit number to be increased, shown by the increase instruction;
a pseudo medal detection pulse generation unit adapted to generate pseudo medal detection pulses;
a first relay output unit adapted to output the medal detection pulses obtained by a logical sum between the normal medal detection pulses and the pseudo medal detection pulses to the first input unit;
a pseudo discharge signal generation unit adapted to generate a pseudo discharge signal that gives an instruction to discharge the inserted medals out of the device in case in which the instruction reception unit has received the increase instruction;
a second relay output unit adapted to output the discharge signal obtained by a logical sum between the normal discharge signal and the pseudo discharge signal to the second input unit; and
a control unit adapted to cause the pseudo medal detection pulse generation unit to generate the pseudo medal detection pulses, whose number corresponds to the first increase credit number stored in the storage unit, after the pseudo discharge signal is generated.

2. A relay device connected to a game device comprising:
a first output unit adapted to detect medals inserted from a medal insertion port by a medal insertion sensor, and adapted to output normal medal detection pulses;
a first input unit supplied with medal detection pulses;
a credit management unit adapted to count up and manage a credit number corresponding to the medal detection pulses supplied to the first input unit;
a second output unit adapted to output a normal discharge signal that causes the inserted medals to be discharged out of the device;
a second input unit supplied with a discharge signal; and
a discharge unit adapted to discharge the inserted medals out of the device, without causing the medal insertion sensor to detect the inserted medals, according to the discharge signal supplied to the second input unit, the relay device comprising:
a communication unit adapted to communicate with an outside device;
an instruction reception unit adapted to receive an increase instruction that increases the credit number via the communication unit;
a normal medal detection pulse input unit supplied with the normal medal detection pulses outputted from the first output unit;
a pseudo medal detection pulse generation unit adapted to generate pseudo medal detection pulses;
a storage unit adapted to store a first increase credit number as the credit number to be increased shown by the increase instruction, and a second increase credit number obtained by counting the normal medal detection pulses supplied to the normal medal detection pulse input unit;
a pseudo discharge signal generation unit adapted to generate a pseudo discharge signal that gives an instruction to discharge the inserted medals out of the device;
a second relay output unit adapted to output the discharge signal obtained by a logical sum between the normal discharge signal and the pseudo discharge signal to the second input unit; and
a control unit adapted to cause the pseudo medal detection pulse generation unit to generate the pseudo medal detection pulses, whose number corresponds to the first increase credit number and the second increase credit number stored in the storage unit, after the pseudo discharge signal is generated.

3. The relay device according to claim 1, further comprising:
an acquisition credit number input unit adapted to allow a player to input an acquisition credit number as the credit number to be acquired in the game device, out of the first increase credit number stored in the storage unit; and
an acquisition instruction unit adapted to allow the player to input an acquisition instruction to acquire the acquisition credit number to the game device,
wherein the control unit updates contents stored in the storage unit by a new first increase credit number obtained by subtracting the acquisition credit number from the first increase credit number after the acquisition instruction is inputted, and causes the pseudo medal detection pulse generation unit to generate the pseudo medal detection pulses, whose number corresponds to the acquisition credit number, after the pseudo discharge signal is generated.

4. The relay device according to claim 2, further comprising:
an acquisition credit number input unit adapted to allow a player to input an acquisition credit number as the credit number to be acquired in the game device, out of the increase credit number stored in the storage unit; and
an acquisition instruction unit adapted to allow the player to input an acquisition instruction to acquire the acquisition credit number to the game device,
wherein the control unit causes the storage unit to store an increase credit number obtained by making an operation to obtain a sum of the first increase credit number and the second increase credit number, instead of causing the storage unit to store the first increase credit number and the second increase credit number, and
wherein the control unit updates contents stored in the storage unit by a new increase credit number obtained by subtracting the acquisition credit number from the increase credit number after the acquisition instruction is inputted, and causes the pseudo medal detection pulse generation unit to generate the pseudo medal detection pulses, whose number corresponds to the acquisition credit number, after the pseudo discharge signal is generated.

5. The relay device according to claim 1 or claim 2, further comprising:
a display unit adapted to display information; and an inserting pulse interval detection unit adapted to cause the display unit to display an image encouraging the player to insert the medals consecutively, and to measure a pulse interval of the normal medal detection pulses,
wherein the pseudo medal detection pulse generation unit controls the pulse interval of the pseudo medal detection pulses so that the pulse interval of the pseudo medal detection pulses is greater than a minimum pulse interval among a plurality of pulse intervals measured by the inserting pulse interval detection unit.

6. The relay device according to claim 1, wherein the game device comprises:
a hopper to store the medals,
a motor provided to the hopper to operate for paying out the medals,
a main body board adapted to output a normal drive signal for operating the motor,
a medal paying-out sensor to detect the medals paid out from the hopper and to output normal medal paying-out pulses,
a medal paying-out pulse input unit supplied with the medal paying-out pulses, and
a management unit adapted to count the medal paying-out pulses supplied to the medal paying-out pulse input unit and to subtract a result of the count from the credit number,
wherein the communication unit communicates with a credit storage device; and
wherein the relay device further comprises:
a transfer input unit adapted to allow the player to input an output instruction that gives an instruction to output the credit number held in the game device,
a motor control unit adapted to supply to the motor a pseudo drive signal that stops operation of the motor when the output instruction is inputted to the transfer input unit,
a pseudo medal paying-out pulse generation unit adapted to output pseudo medal paying- out pulses during a period when sensing the normal drive signal that is outputted from the main body board and that operates the motor, after stopping the operation of the motor,
a medal paying-out pulse output unit adapted to output to the medal paying-out pulse input unit the medal paying-out pulses obtained by a logical sum between the normal medal paying-out pulses and the pseudo medal paying-out pulses, and
a credit number transfer unit adapted to generate a credit number to be transferred from the game device to the credit storage device according to a number of the pseudo medal paying- out pulses outputted from the pseudo medal paying-out pulse generation unit, and to transfer the generated credit number to the credit storage device via the communication unit.

7. The relay device according to claim 1, further comprising:
a monitor unit adapted to monitor a control signal of an element of the game device; and
a pseudo game participation information transmission unit adapted to generate pseudo bet information corresponding to bet information or pseudo win information corresponding to win information that show an extent of participation in the game by the player, based on at least the control signal monitored by the monitor unit, and to transmit the information to a management device via the communication unit.

8. The relay device according to claim 7, further comprising:
a reading unit adapted to read identification information from a recording medium recording the identification information for identifying the player, and to output a read out signal,
wherein the pseudo game participation information transmission unit generates the pseudo bet information corresponding to the bet information or the pseudo win information corresponding to the win information that show the extent of participation in the game by the player, based on at least the read out signal and the control signal monitored by the monitor unit, and to transmit the information to the management device via the communication unit.

9. A game system comprising:
a management device;
a plurality of first game devices adapted not to communicate with the management device;
a plurality of second game devices adapted to communicate with the management device; and
a plurality of relay devices provided correspondingly to the plurality of first game devices,
wherein each of the plurality of first game devices comprises:
a first output unit adapted to detect medals inserted from a medal insertion port by a medal insertion sensor, and to output normal medal detection pulses,
a first input unit supplied with medal detection pulses,
a credit management unit adapted to count up and manage a credit number corresponding to the medal detection pulses supplied to the first input unit,
a second output unit adapted to output a normal discharge signal that causes the inserted medals to be discharged out of the device,
a second input unit supplied with a discharge signal, and
a discharge unit adapted to discharge the inserted medals out of the device, without causing the medal insertion sensor to detect the inserted medals, according to the discharge signal supplied to the second input unit, and
wherein each of the plurality of relay devices comprises:
a communication unit adapted to communicate with the management device,
an instruction reception unit adapted to receive an increase instruction that increases the credit number via the communication unit,
a storage unit adapted to store a first increase credit number as the credit number to be increased shown by the increase instruction,
a pseudo medal detection pulse generation unit adapted to generate pseudo medal detection pulses,
a first relay output unit adapted to output the medal detection pulses obtained by a logical sum between the normal medal detection pulses and the pseudo medal detection pulses to the first input unit,
a pseudo discharge signal generation unit adapted to generate a pseudo discharge signal that gives an instruction to discharge the inserted medals out of the device when the instruction reception unit receives the increase instruction,
a second relay output unit adapted to output the discharge signal obtained by a logical sum between the normal discharge signal and the pseudo discharge signal to the second input unit, and
a control unit adapted to cause the pseudo medal detection pulse generation unit to generate the pseudo medal detection pulses, whose number corresponds to the first increase credit number stored in the storage unit, after the pseudo discharge signal is generated.

10. A game system comprising:
a management device;
a plurality of first game devices adapted not to communicate with the management device;
a plurality of second game devices adapted to communicate with the management device; and
a plurality of relay devices provided correspondingly to the plurality of first game devices,
wherein each of the plurality of first game devices comprises:
a first output unit adapted to detect medals inserted from a medal insertion port by a medal insertion sensor, and to output normal medal detection pulses,
a first input unit supplied with medal detection pulses,
a credit management unit adapted to count up and manage a credit number corresponding to the medal detection pulses supplied to the first input unit,
a second output unit adapted to output a normal discharge signal that causes the inserted medals to be discharged out of the device,
a second input unit supplied with a discharge signal, and
a discharge unit adapted to discharge the inserted medals out of the device, without causing the medal insertion sensor to detect the inserted medals, according to the discharge signal supplied to the second input unit, and
wherein each of the plurality of relay devices comprises:
a communication unit adapted to communicate with the management device,
an instruction reception unit adapted to receive an increase instruction that increases the credit number via the communication unit,
a normal medal detection pulse input unit supplied with the normal medal detection pulses outputted from the first output unit,
a pseudo medal detection pulse generation unit adapted to generate pseudo medal detection pulses,
a storage unit adapted to store a first increase credit number as the credit number to be increased shown by the increase instruction, and a second increase credit number obtained by counting the normal medal detection pulses supplied to the normal medal detection pulse input unit,
a pseudo discharge signal generation unit adapted to generate a pseudo discharge signal that gives an instruction to discharge the inserted medals out of the device,
a second relay output unit adapted to output the discharge signal obtained by a logical sum between the normal discharge signal and the pseudo discharge signal to the second input unit, and
a control unit adapted to cause the pseudo medal detection pulse generation unit to generate the pseudo medal detection pulses, whose number corresponds to the first increase credit number and the second increase credit number stored in the storage unit, after the pseudo discharge signal is generated.

11. The relay device according to claim 2, further comprising:
a display unit adapted to display information; and an inserting pulse interval detection unit adapted to cause the display unit to display an image encouraging the player to insert the medals consecutively, and to measure a pulse interval of the normal medal detection pulses,
wherein the pseudo medal detection pulse generation unit controls the pulse interval of the pseudo medal detection pulses so that the pulse interval of the pseudo medal detection pulses is greater than a minimum pulse interval among a plurality of pulse intervals measured by the inserting pulse interval detection unit.

12. The relay device according to claim 2, wherein the game device comprises:
a hopper to store the medals,
a motor provided to the hopper to operate for paying out the medals,
a main body board adapted to output a normal drive signal for operating the motor,
a medal paying-out sensor to detect the medals paid out from the hopper and to output normal medal paying-out pulses,
a medal paying-out pulse input unit supplied with the medal paying-out pulses, and
a management unit adapted to count the medal paying-out pulses supplied to the medal paying-out pulse input unit and to subtract a result of the count from the credit number,
wherein the communication unit communicates with a credit storage device; and
wherein the relay device further comprises:
a transfer input unit adapted to allow the player to input an output instruction that gives an instruction to output the credit number held in the game device,
a motor control unit adapted to supply to the motor a pseudo drive signal that stops operation of the motor when the output instruction is inputted to the transfer input unit,
a pseudo medal paying-out pulse generation unit adapted to output pseudo medal paying-out pulses during a period when sensing the normal drive signal that is outputted from the main body board and that operates the motor, after stopping the operation of the motor,
a medal paying-out pulse output unit adapted to output to the medal paying-out pulse input unit the medal paying-out pulses obtained by a logical sum between the normal medal paying-out pulses and the pseudo medal paying-out pulses, and
a credit number transfer unit adapted to generate a credit number to be transferred from the game device to the credit storage device according to a number of the pseudo medal paying- out pulses outputted from the pseudo medal paying-out pulse generation unit, and to transfer the generated credit number to the credit storage device via the communication unit.

13. The relay device according to claim 2, further comprising:
a monitor unit adapted to monitor a control signal of an element of the game device; and
a pseudo game participation information transmission unit adapted to generate pseudo bet information corresponding to bet information or pseudo win information corresponding to win information that show an extent of participation in the game by the player, based on at least the control signal monitored by the monitor unit, and to transmit the information to a management device via the communication unit.

14. The relay device according to claim 13, further comprising:
a reading unit adapted to read identification information from a recording medium recording the identification information for identifying the player, and to output a read out signal,
wherein the pseudo game participation information transmission unit generates the pseudo bet information corresponding to the bet information or the pseudo win information corresponding to the win information that show the extent of participation in the game by the player, based on at least the read out signal and the control signal monitored by the monitor unit, and to transmit the information to the management device via the communication unit.
